(19) United States
(12) Patent Application Publication
(10) Pub. No.: US 2009/0106045 A1
(43) Pub. Date: Apr. 23, 2009

(54) SYSTEM AND METHOD OF TRANSMITTING EMERGENCY CONDITION USING WIRELESS SENSOR NETWORK

(75) Inventors: Jang sik BAE, Daegu (KR); Kyu hyung Kim, Daejeon (KR); Gwang Su Kim, Daejeon (KR); Ho Geun Lee, Daejeon (KR)

Correspondence Address: AMPACC LAW GROUP, 13024 Beverly Park Road, Suite 205, Mukilteo, WA, 98275, US

(73) Assignee: Electronics and Telecommunications Research Institute, Daejeon (KR)

(21) Appl. No.: 12/179,551

(22) Filed: Jul. 24, 2008

(30) Foreign Application Priority Data
Oct. 22, 2007 (KR) 10-2007-0106062

(51) Int. Cl. G06Q 10/00

(52) U.S. Cl. 705/2; 340/539.1

(57) ABSTRACT

The present invention relates to a system and method of transmitting an emergency condition using a wireless sensor network that transmits a user's emergency condition using a wireless sensor network. A wireless sensor network communication device integrated with a biological sensor is attached to a user's body in order to gather user's biological information, and transmits the user's biological information through the wireless sensor network. A repeater receives the biological information from the communication device, and sends the received biological information by using a routing protocol of the wireless sensor network. A management server receives the biological information through the repeater, analyzes the biological information, and transmits a warning signal to a user or takes emergency measures. Therefore, it is possible to detect and cope with sudden physical problems, which are generated during user's exercises and outdoor activities, at an early stage. As a result, it is possible to significantly contribute to the prevention and reduction of danger for the weak and the elderly, and a user who is to be taken care of.

### CROSS-REFERENCE TO RELATED APPLICATION

This application claims priority to and the benefit of Korean Patent Application No. 10-2007-0106062 filed in the Korean Intellectual Property Office on Oct. 22, 2007, the entire contents of which are incorporated herein by reference.

### BACKGROUND OF THE INVENTION

(a) Field of the Invention

The present invention relates to a system and method of transmitting an emergency condition using a wireless sensor network. More particularly, the present invention relates to a system and method of transmitting an emergency condition using a wireless sensor network that transmits a user's emergency condition using a wireless sensor network.

(b) Description of the Related Art

FIG. 1 is a schematic view of a general ubiquitous sensor network.

As shown in FIG. 1, a sensor network 110 is a kind of an ad-hoc network, and includes a plurality of sensor nodes 111 and sink nodes 112 for specific purposes. In order to provide information gathered through the sensor network 110 to a user, the information may be provided through an existing IP (Internet protocol)-based network (BcN) 130. For this purpose, the information is transmitted through a gateway 120.

Further, a server 131 is needed to provide various application services based on a ubiquitous sensor network. The sensor node 111 has a sensing function to sense peripheral information, a transmission function to transmit the peripheral information to another node, and a reception function to receive information transmitted from another sensor node.

Each of the sensor nodes 111 of the wireless sensor network having the above-mentioned configuration set a channel to a destination in order to send information to a destination by exchanging data, periodically or as necessary, according to a routing protocol between the sensor nodes 111. Each of the sensor nodes provides a function to detect defects on the channel on the basis of the information sent according to the routing protocol, and to repair defects of the wireless sensor network by changing the channel, if necessary.

FIG. 2 is a view schematically illustrating an operation for transmitting information, which is gathered by a sensor node, to a server on the general ubiquitous sensor network.

As shown in FIG. 2, the sensor node 111 senses information (e.g., ambient temperature, humidity, or the like), which can be gathered by using sensors (e.g., temperature sensor, humidity sensor, or the like) mounted thereon, by using the sensors.

Then, the gathered sensor information is sent to the sink node 112. In this case, the sink node 112 transmits the information to the gateway 120.

Accordingly, the server 131 can receive related data through the gateway 120, store the received information, and process the information in order to apply the information to various applications.

FIG. 3 is a view illustrating a method of transmitting user's information using an existing mobile communication network.

As shown in FIG. 3, a user can transmit own information (i.e., user information) to a server 330 through a mobile communication base station 320 by using an own mobile communication terminal 310.

However, when user's biological information is transmitted by using the existing mobile communication network as described above, there has been a drawback in that the user should always carry the mobile communication terminal 310 in addition to a device used to gather user's biological information. Further, since the user's biological information gathered using the above-mentioned existing mobile communication network is transmitted to the server, there has been a drawback in that additional cost is required for using a mobile communication network.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method of transmitting a user's emergency condition using a wireless sensor network.

Further, the present invention is to detect and cope with sudden physical problems, which are generated during user's outdoor activities, at an early stage and to significantly contribute to the safety of the weak and the elderly and a user who is to be taken care of, by gathering user's biological information and monitoring a user's state in real time by a management server through a wireless sensor network.

An exemplary embodiment of the present invention provides a system and method of transmitting an emergency condition using a wireless sensor network communication technology that automatically gathers users' biological information in a predetermined region by using wireless sensor network communication technology, transmits the gathered biological information to a management server by using the wireless sensor network communication technology, and takes corresponding measures. In this case, according to the exemplary embodiment of the present invention, a device integrated with a biological sensor is attached to a user's body, user's biological information gathered by the device is transmitted to the management server through a repeater by using the wireless sensor network communication technology, the management server grasps a user's state so as to detect an emergency condition caused by user's physical problems, a warning message is transmitted to the user, and an accident is quickly coped with when it occurs. Therefore, it is possible to reduce and prevent the danger of an accident that may occur during exercise and outdoor activities.

An exemplary embodiment of the present invention provides a system for transmitting an emergency condition using a wireless sensor network. The system includes a wireless sensor network communication device integrated with a biological sensor, a repeater, and a management server. The wireless sensor network communication device integrated with a biological sensor is attached to a user's body in order to gather user's biological information, and transmits the user's biological information through the wireless sensor network. The repeater receives the biological information from the communication device, and sends the received biological information by using a routing protocol of the wireless sensor network. The management server receives the biological information through the repeater, analyzes the biological information, and transmits a warning signal to a user or takes emergency measures.

In this case, the communication device may include a biological information sensing unit, a wireless sensor network communication unit, and an output unit. The biological information sensing unit is attached to the user's body in order to periodically measure user's biological information. The wireless sensor network communication unit receives the biological information measured by the biological information sensing unit, transmits the biological information to the repeater through the wireless sensor network, and receives a warning signal through the repeater. The output unit sends the warning signal received from the wireless sensor network communication unit to the user. Further, the repeater may form the wireless sensor network together with other peripheral repeaters, may route the biological information received from the communication device to other repeaters or sends the biological information to the management server by using a routing protocol of the wireless sensor network, and may detect and repair defects on the wireless sensor network. Furthermore, the management server may grasp the user's present state by using the biological information received through the repeater, may send a warning signal to the user if an abnormal indication is generated, and may cause an emergency rescue organization to take emergency measures if an emergency condition occurs.

Another exemplary embodiment of the present invention provides a method of transmitting an emergency condition using a wireless sensor network in a sensor network communication device integrated with a biological sensor, which is attached to a user. The method includes searching peripheral repeaters and determining whether the number of searched repeaters is one or not, setting a communication channel corresponding to the searched repeater if one repeater is searched, gathering user's biological information by using a biological sensor, and transmitting the gathered biological information to the repeater where the communication channel is set.

Further, the method of transmitting an emergency condition may further include selecting a repeater having the highest communication sensitivity among the searched repeaters if two or more repeaters are searched, and setting a communication channel corresponding to the selected repeater.

Another exemplary embodiment of the present invention provides a method of transmitting an emergency condition using a wireless sensor network in a repeater. The method includes attempting to form the wireless sensor network together with other peripheral repeaters, periodically checking the state of the formed wireless sensor network after the wireless sensor network is formed, receiving biological information from a sensor network communication device integrated with a biological sensor if troubles do not occur on the formed wireless sensor network, and sending the received biological information to a management server through the formed wireless sensor network.

Further, the method of transmitting an emergency condition may further include re-searching a channel of the wireless sensor network if troubles occur on the formed wireless sensor network, and resetting a channel of the re-searched wireless sensor network instead of the formed wireless sensor network.

Another exemplary embodiment of the present invention provides a method of transmitting an emergency condition using a wireless sensor network in a management server. The method includes receiving user's biological information through the wireless sensor network, analyzing the received user's biological information, determining whether an abnormal indication is detected or not on the basis of the analysis result, determining whether the occurrence of an accident is perceived if the abnormal indication is detected, and taking measures of emergency rescue for the user if the occurrence of the accident is perceived.

In this case, the taking of the measures of emergency rescue may include informing an emergency rescue organization of an emergency condition, when the emergency condition occurs, so that the emergency rescue organization takes emergency measures for the user.

Further, the method of transmitting an emergency condition may further include generating a warning signal corresponding to the abnormal indication of the user's body and transmitting the warning signal to the user if the occurrence of the accident is not perceived.

As described above, according to the present invention, a wireless sensor network communication device integrated with a biological sensor is attached to a user's body in order to gather user's biological information, a user's state is transmitted to a management server using the wireless sensor network, an emergency condition caused by user's physical problems is monitored in real time, and a warning message is transmitted to a user so that an accident is quickly coped with during the occurrence of the accident. Therefore, it is possible to detect and cope with sudden physical problems, which are generated during user's exercise and outdoor activities, at an early stage. As a result, it is possible to significantly contribute to the prevention and reduction of danger for the weak and the elderly, and a user who is to be taken care of.

### BRIEF DESCRIPTION OF THE DRAWINGS

FIG. 1 is a schematic view of a general wireless sensor network.

FIG. 2 is a flowchart illustrating a method of transmitting information gathered at a sensor node of the general wireless sensor network.

FIG. 3 is a view showing the configuration of a user information transmission system in the prior art.

FIG. 4 is a schematic block diagram of a system for transmitting an emergency condition using a wireless sensor network according to an exemplary embodiment of the present invention.

FIG. 5 is a view showing the configuration of a wireless sensor network communication device integrated with a biological sensor according to an exemplary embodiment of the present invention.

FIG. 6 is a flowchart illustrating a method of transmitting an emergency condition using a wireless sensor network according to an exemplary embodiment of the present invention.

FIG. 7 is a flowchart illustrating a method of transmitting an emergency condition in the wireless sensor network communication device integrated with a biological sensor according to an exemplary embodiment of the present invention.

FIG. 8 is a flowchart illustrating a method of transmitting an emergency condition in a repeater according to an exemplary embodiment of the present invention.

FIG. 9 is a flowchart illustrating a method of transmitting an emergency condition in a management server according to an exemplary embodiment of the present invention.

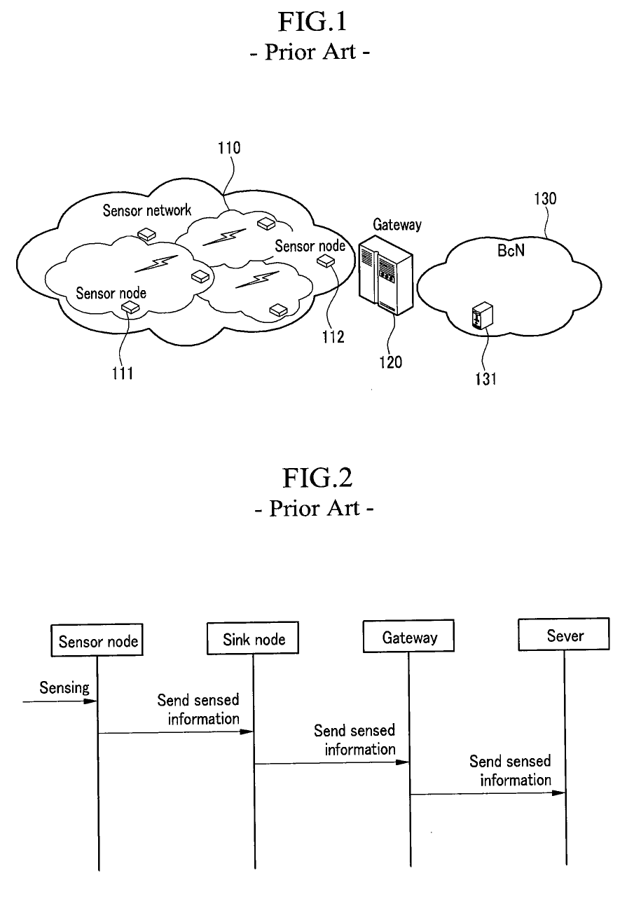

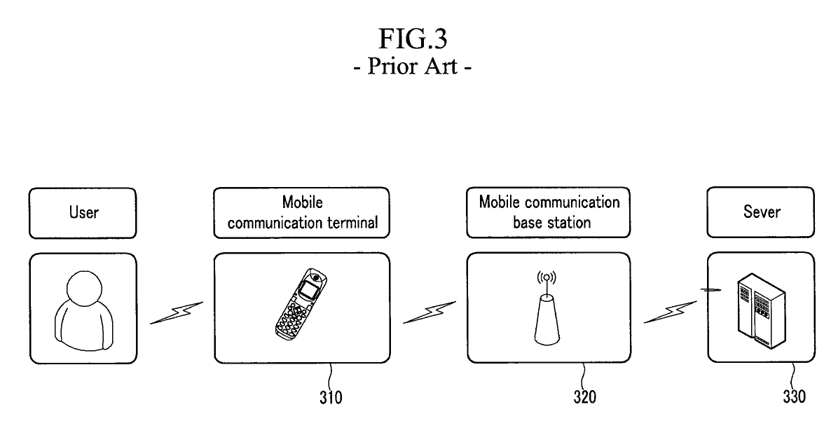

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, the terms “-er”, “-or”, and “module” described in the specification mean units for processing at least one function and operation, and can be implemented by hardware components or software components, and combinations thereof.

A system and method of transmitting an emergency condition using a wireless sensor network according to exemplary embodiments of the present invention will be described in detail below with reference to drawings.

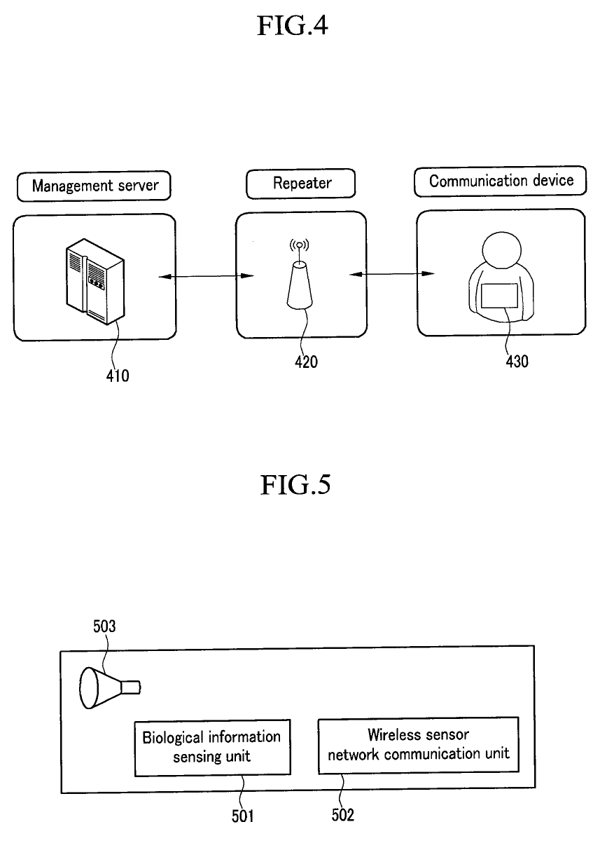

FIG. 4 is a schematic block diagram of a system for transmitting an emergency condition using a wireless sensor network according to an exemplary embodiment of the present invention.

As shown in FIG. 4, a system for transmitting an emergency condition using a wireless sensor network according to an exemplary embodiment of the present invention includes a management server 410, a repeater 420, and a communication device 430. In this case, the repeater 420 performs communication between the management server 410 and the communication device 430 according to a wireless sensor network method using a routing protocol.

The management server 410 analyzes a biological signal (i.e., user's biological information) that is received from the repeater 420, and performs an operation (i.e., an operation for taking emergency measures or transmitting a warning signal) corresponding to an aware context through the present context-awareness. In this case, the management server 410 receives a user's biological signal through the repeater 420. Further, the management server 410 grasps the user's present state by using user's biological information received through the repeater 420. If an abnormal indication is generated (i.e., if the danger is acknowledged), the management server sends a warning signal to a user. If an emergency condition occurs (i.e., if the danger occurs), the management server provides an emergency rescue service (e.g., takes emergency measures through an emergency rescue organization).

The repeater 420 routes a biological signal, which is received from the communication device 430, to other peripheral repeaters (not shown in the drawing for convenience of description) by using a routing protocol of the wireless sensor network, or sends received data (biological information) to the management server 410. In this case, the repeater 420 receives user's biological information through the wireless communication with the communication device 430. Further, the repeater 420 forms a wireless sensor network together with other peripheral repeaters, and sends a biological signal, which is transmitted from the user's communication device 430 through the wireless sensor network formed by the repeaters, to the management server 410. Furthermore, the repeater 420 automatically detects defects on the wireless sensor network, and repairs the defects.

The communication device 430 is a wireless sensor network communication device integrated with a biological sensor. The communication device is attached to a user's body in order to gather biological information such as respiration and pulse of a user by using a wireless sensor network communication technology, and transmits the gathered biological information to the repeater 420 through the wireless sensor network as a biological signal. In this case, the communication device 430 periodically gathers a user's biological signal, and transmits the gathered biological signal to the management server 410 through the repeater 420 by using the wireless sensor network.

FIG. 5 is a view showing the configuration of a wireless sensor network communication device integrated with a biological sensor according to an exemplary embodiment of the present invention.

As shown in FIG. 5, the wireless sensor network communication device integrated with a biological sensor according to an exemplary embodiment of the present invention includes a biological information sensing unit 501, a wireless sensor network communication unit 502, and a speaker 503.

The biological information sensing unit 501 is a biological sensor for measuring biological information, such as user's bloodstream and the number of user's heartbeats. The biological information sensing unit sends the biological information, which is measured by the biological sensor, to the wireless sensor network communication unit 502.

The wireless sensor network communication unit 502 receives biological information measured by the biological information sensing unit 501, and transmits the biological information to the repeater 420 wirelessly as a biological signal. Further, the wireless sensor network communication unit 502 receives a warning signal, which is transmitted from the management server 410 through the repeater 420, and sends the warning signal to the speaker 503.

The speaker 503 sends the warning signal, which is transmitted through the wireless sensor network communication unit 502, to a user. In this case, the speaker 503 has been used to send the warning signal to a user in the exemplary embodiment of the present invention. However, the present invention is not limited thereto, and it should be understood that all kinds of output units such as a LCD (liquid crystal display) and a vibrator that are capable of sending a warning signal to a user may be used.

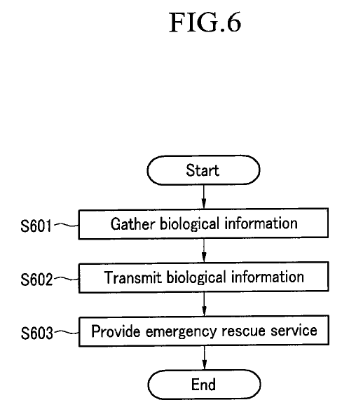

A method of transmitting an emergency condition using a wireless sensor network according to an exemplary embodiment of the present invention will be described in detail below with reference to FIGS. 6 to 9.

FIG. 6 is a flowchart illustrating a method of transmitting an emergency condition using a wireless sensor network according to an exemplary embodiment of the present invention.

As shown in FIG. 6, the wireless sensor network communication device 430 integrated with a biological sensor that is attached to the user's body gathers user's biological information (S601), performs wireless communication by using other peripheral repeaters, and transmits the gathered biological information by using a channel of the wireless communication. That is, the wireless sensor network communication device 430 integrated with a biological sensor, which is attached to the user's body in order to gather biological information, transmits biological information that is gathered by the closest repeater 420.

Further, the repeater 420 transmits the biological information, which is gathered by the wireless sensor network communication device 430 integrated with a biological sensor, to the management server 410 through the wireless network that is formed between the other peripheral repeaters and its own (S602).

In this case, when the wireless sensor network communication device 430 integrated with a biological sensor communicates with the repeater 420 through the wireless sensor network, the wireless sensor network communication device 430 integrated with a biological sensor selects a repeater 420 having the best communication sensitivity among the repeaters that can communicate therewith and generates a communication channel. Further, the repeater 420 is provided at a street lamp and users' surroundings, receives the gathered biological information from the wireless sensor network communication device 430 integrated with a biological sensor that is used by users, forms a wireless network together with other peripheral repeaters in order to transmit the received biological information to the management server 410, and transmits the transmitted biological information to the management server 410 through the wireless network. Furthermore, the repeaters 420 form a wireless network using a routing protocol. Accordingly, when errors occur on the wireless network due to the error of any repeater, the repeater 420 automatically detects defects on the wireless sensor network and repairs the defects. In addition, when biological information to be transmitted to the management server 410 is generated during the repair, the repeaters except for the repeater having the error reforms a wireless network so that the biological information is transmitted to the management server 410. Therefore, the emergency condition transmission and an emergency rescue service are not interrupted.

Further, the management server 410 receives user's biological information from the repeater 420, analyzes the received user's biological information, and transmits a warning signal or performs an operation for coping with the danger on the basis of the analysis result (S603).

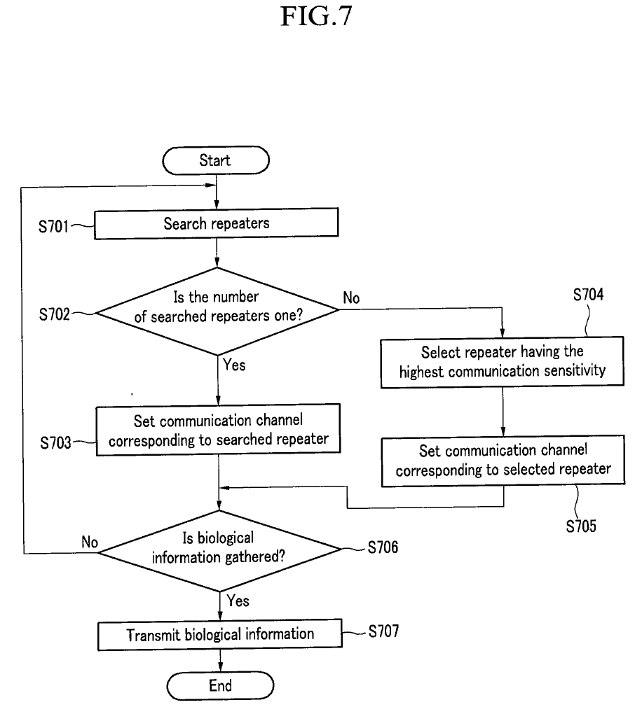

FIG. 7 is a flowchart illustrating a method of transmitting an emergency condition in the wireless sensor network communication device integrated with a biological sensor according to an exemplary embodiment of the present invention.

When power is turned on and applied to the wireless sensor network communication device 430 integrated with a biological sensor as shown in FIG. 7, the wireless sensor network communication unit 502 searches peripheral repeaters 420 to perform wireless communication (S701). In this case, the wireless sensor network communication unit 502 confirms the result searched in step S701, and determines whether the number of searched repeaters 420 is one or not (S702).

If one repeater 420 is searched in step S702, the wireless sensor network communication unit 502 sets a communication channel corresponding to the searched repeater 420 (S703).

In contrast, if two or more repeaters 420 are searched in step S702, the wireless sensor network communication unit 502 selects a repeater 420 having the highest communication sensitivity among the searched repeaters (S704) and then sets a communication channel corresponding to the selected repeater 420 (S705).

After that, the biological information sensing unit 501 gathers user's biological information by using the biological sensor (S706), and the wireless sensor network communication device 430 integrated with a biological sensor then sends the gathered biological information to the wireless sensor network communication unit 502.

In this case, if user's biological information is not gathered in step S706, the wireless sensor network communication device 430 integrated with a biological sensor periodically performs the operations of steps S701 to S705 in order to set a communication channel that is required for an optimum emergency condition transmission service at all times.

The wireless sensor network communication unit 502 receives biological information gathered by the biological information sensing unit 501, and transmits the biological information to a repeater 420 where the communication channel is set in step S705 (S707).

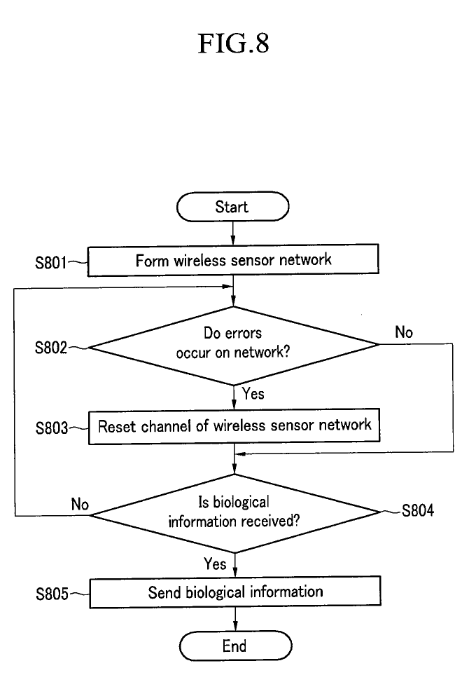

FIG. 8 is a flowchart illustrating a method of transmitting an emergency condition in a repeater according to an exemplary embodiment of the present invention.

When power is turned on and applied to the repeater 420 as shown in FIG. 8, the repeater attempts to form a wireless sensor network together with other peripheral repeaters and forms the wireless sensor network (S801).

Further, the repeater 420 periodically checks the state of the wireless sensor network formed in step S801 in order to determine whether errors occur on the network (S802). In this case, if errors occur on the network, the repeater 420 searches a new channel to the management server 410 and resets the channel (S803). That is, if errors occur on the network, the repeater 420 re-searches a channel of the wireless sensor network and then resets the re-searched channel of the wireless sensor network.

After that, the repeater 420 receives the biological information that is transmitted from the wireless sensor network communication device 430 integrated with a biological sensor (S804), and sends the received biological information to the management server 410 through the wireless sensor network that is formed in step S801 (or S803) (S805).

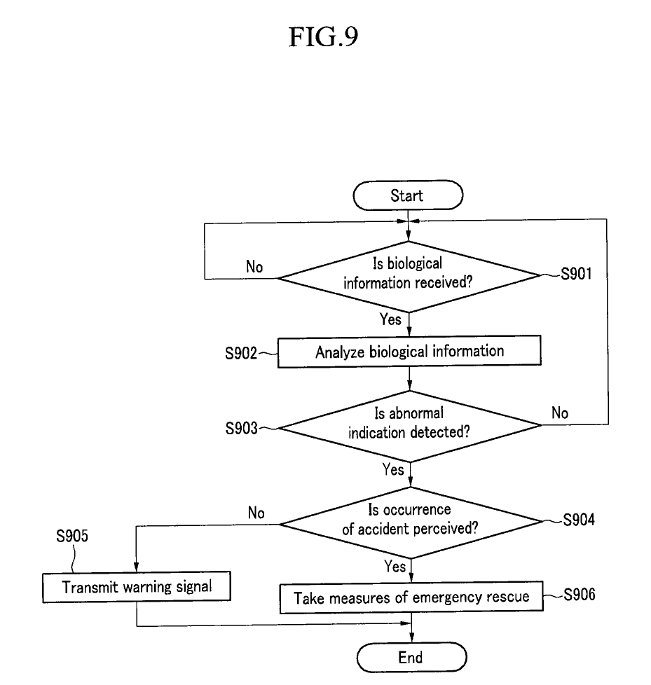

FIG. 9 is a flowchart illustrating a method of transmitting an emergency condition in a management server according to an exemplary embodiment of the present invention.

When power is turned on and applied to the management server 410 as shown in FIG. 9, the management server receives user's biological information through the wireless sensor network formed as described above (S901) and analyzes the received user's biological information (S902). In this case, the management server 410 includes a database that stores and manages information about the emergency measures corresponding to the received user's biological information. Accordingly, the management server reads out the information about the emergency measures corresponding to the received user's biological information from the database, and analyzes the information.

Further, the management server 410 determines whether an abnormal indication is detected or not, on the basis of the analysis result of step S902 (S903). In this case, if it is determined in step S903 that an abnormal indication is detected on the basis of the analysis result, the management server 410 determines whether a user perceives the occurrence of an accident (S904).

If the user does not perceive the occurrence of an accident in step S904, the management server 410 generates a warning signal corresponding to the abnormal indication of the user's body, and transmits the warning signal to the sensor network communication device 430 integrated with a biological sensor through the wireless sensor network formed as described above in order to inform the user of the occurrence of an accident (S905).

In contrast, when the user perceives the occurrence of an accident in step S904, the management server 410 takes measures of emergency rescue for the user (S906).

For example, when an emergency condition occurs, the management server 410 informs an emergency rescue organization of the emergency condition so that the emergency rescue organization takes emergency measures for the user.

As described above, according to the exemplary embodiments of the present invention, user's biological information is gathered and a user's state is monitored in real time by a management server through a wireless sensor network. Therefore, when an abnormality is detected, a warning message is transmitted to the user so that unexpected incidents caused by sudden physical problems during a user's outdoor activity are detected at an early stage in order to reduce death and injury.

The exemplary embodiments of the present invention are not embodied only by the above-mentioned system and/or method. Alternatively, the above-mentioned exemplary embodiments may be embodied by a program performing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for transmitting an emergency condition using a wireless sensor network, the system comprising:
a wireless sensor network communication device integrated with a biological sensor that is attached to a user's body in order to gather user's biological information, and that transmits the user's biological information through the wireless sensor network;
a repeater that receives the biological information from the communication device and sends the received biological information by using a routing protocol of the wireless sensor network; and
a management server that receives the biological information through the repeater, analyzes the biological information, and transmits a warning signal to a user or takes emergency measures.

2. The system of claim 1, wherein the communication device includes:
a biological information sensing unit that is attached to the user's body in order to periodically measure user's biological information;
a wireless sensor network communication unit that receives the biological information measured by the biological information sensing unit, transmits the biological information to the repeater through the wireless sensor network, and receives a warning signal through the repeater; and
an output unit that sends the warning signal received from the wireless sensor network communication unit to the user.

3. The system of claim 1, wherein the repeater forms the wireless sensor network together with other peripheral repeaters, routes the biological information received from the communication device to other repeaters or sends the biological information to the management server by using a routing protocol of the wireless sensor network, and detects and repairs defects on the wireless sensor network.

4. The system of claim 1, wherein the management server grasps the user's present state by using the biological information received through the repeater, sends a warning signal to the user if an abnormal indication is generated, and causes an emergency rescue organization to take emergency measures if an emergency condition occurs.

5. A method of transmitting an emergency condition using a wireless sensor network in a sensor network communication device integrated with a biological sensor, which is attached to a user, the method comprising:
searching peripheral repeaters and determining whether the number of searched repeaters is one or not;
setting a communication channel corresponding to the searched repeater if one repeater is searched;
gathering user's biological information by using a biological sensor; and
transmitting the gathered biological information to the repeater where the communication channel is set.

6. The method of claim 5, further comprising:
selecting a repeater having the highest communication sensitivity among the searched repeaters if two or more repeaters are searched; and
setting a communication channel corresponding to the selected repeater.

7. A method of transmitting an emergency condition using a wireless sensor network in a repeater, the method comprising:
attempting to form the wireless sensor network together with other peripheral repeaters;
periodically checking the state of the formed wireless sensor network after the wireless sensor network is formed;
receiving biological information from a wireless sensor network communication device integrated with a biological sensor if errors do not occur on the formed wireless sensor network; and
sending the received biological information to a management server through the formed wireless sensor network.

8. The method of claim 7, further comprising:
re-searching a channel of the wireless sensor network if errors occur on the formed wireless sensor network; and
resetting a channel of the re-searched wireless sensor network instead of the formed wireless sensor network.

9. A method of transmitting an emergency condition using a wireless sensor network in a management server, the method comprising:
receiving user's biological information through the wireless sensor network;
analyzing the received user's biological information;
determining whether an abnormal indication is detected or not, on the basis of the analysis result;
determining whether the occurrence of an accident is perceived if the abnormal indication is detected; and
taking measures of emergency rescue for the user if the occurrence of the accident is perceived.

10. The method of claim 9, further comprising
generating a warning signal corresponding to the abnormal indication of the user's body and transmitting the warning signal to the user if the occurrence of the accident is not perceived.

11. The method of claim 9, wherein the taking of the measures of emergency rescue includes informing an emergency rescue organization of an emergency condition, when the emergency condition occurs, so that the emergency rescue organization takes emergency measures for the user.
